(19) United States
(12) Patent Application Publication
(10) Pub. No.: US 2012/0133797 A1
(43) Pub. Date: May 31, 2012

(54) IMAGING APPARATUS, IMAGING METHOD AND COMPUTER PROGRAM

(75) Inventors: Hidehiko SATO, Kanagawa (JP); Junzo SAKURAI, Kanagawa (JP)

(73) Assignee: AOF Imaging Technology, Co., LTD., Hong Kong (CN)

(21) Appl. No.: 13/297,561

(22) Filed: Nov. 16, 2011

(30) Foreign Application Priority Data
Nov. 30, 2010 (JP) 2010-266733

(51) Int. Cl. H04N 5/262; H04N 5/228

(52) U.S. Cl. 348/239; 348/222.1; 348/E05.051

(57) ABSTRACT

The present invention provides an imaging apparatus, an imaging method and a computer program which can automatically select an imaging method matching a scene and capture higher quality images. The imaging apparatus analyzes a preview image acquired from the image sensor before a shutter button is operated to classify the scene on which the preview image is obtained and, when the scene classified by the scene classifying unit is a night scene including a night view, controls the image sensor to continuously capture a plurality of images when the shutter button is operated.

### CROSS-REFERENCE TO RELATED APPLICATION

The present application is related to, claims priority from, and incorporates by reference Japanese Patent Application No. 2010-266733 filed on Nov. 30, 2010.

### BACKGROUND OF THE INVENTION

1. Field of the Invention

The present invention relates to an imaging apparatus, an imaging method and a computer program.

2. Description of Related Art

Many digital cameras which are sold in recent years incorporate a function of capturing images according to a mode such as a portrait mode, scenery mode and night scene mode suitable for an image capturing scene. For example, to capture an image of scenery, the user can, for example, set an aperture value high by selecting a scenery mode and set the aperture value to an optimal value as a value of various parameters to capture an image of the scenery.

Further, digital cameras are also proposed in which, when the night scene mode is selected, a plurality of images are captured when a shutter button is pushed once, and the plurality of captured images are combined into a composed image. By combining a plurality of images, it is possible to obtain an image of an expanded dynamic range and an adequate exposure.

For example, JP 2005-86488 A discloses a technique which, to capture an image of a person with a background of a night scene, performs in series low sensitive image capturing while keeping flash firing turned on and high sensitive image capturing while keeping flash firing turned off, extracts an area of the person obtained from the firstly captured image, and combines this area with the portion of the area of the person obtained from the secondly captured image.

### SUMMARY OF THE INVENTION

With the technique disclosed in JP 2005-86488 A, the shutter speed is restricted to suppress camera shake, and therefore there are cases where an adequate exposure is not provided at a portion of a night scene in the background in particular. Generally, when an image is captured by setting the shutter speed to a time longer than a 1/focal distance, camera shake occurs. Further, when an image with a background of an object such as bright fireworks moving in darkness is captured, although it is necessary to set the shutter speed, most of users have difficulty in setting the shutter speed.

It is therefore an object of the present invention to provide an imaging apparatus, an imaging method and a computer program which can automatically select an imaging method matching a scene and capture a higher quality image.

According to an exemplary aspect of the present invention, the imaging apparatus comprises: an image sensor; a scene classifying means which analyzes a preview image acquired from the image sensor before a shutter button is operated, and classifies the scene on which the preview image is obtained; an imaging control means which, when the scene classified by the scene classifying unit is a night scene including a night view, controls the image sensor to continuously capture a plurality of images when the shutter button is operated.

According to another exemplary aspect of the present invention, an imaging method of an imaging apparatus comprising an image sensor comprises: analyzing a preview image acquired from the image sensor before a shutter button is operated to classify the scene on which the preview image is obtained; and when the scene is classified as a night scene including a night view, controlling the image sensor to continuously capture a plurality of images when the shutter button is operated.

According to another exemplary aspect of the present invention, a computer program of causing a computer to execute image capturing processing of an imaging apparatus comprising an image sensor comprises: analyzing a preview image acquired from the image sensor before a shutter button is operated to classify the scene on which the preview image is obtained; and, when the scene is classified as a night scene including a night view, controlling the image sensor to continuously capture a plurality of images when the shutter button is operated.

According to the present invention, it can be provide an imaging apparatus, an imaging method and a computer program which can automatically select an imaging method matching a scene and capture a higher quality image.

### BRIEF DESCRIPTION OF THE DRAWINGS

Specific embodiments of the present invention will now be described, by way of example only, with reference to the accompanying drawings in which:

FIG. 1 is a block diagram illustrating a configuration example of an imaging apparatus according to the according to an exemplary embodiment;

FIG. 2 is a view describing a function of the imaging apparatus;

FIG. 3 is a block diagram illustrating a functional configuration example of the imaging apparatus;

FIG. 4 is a view describing a method of deciding whether or not a subject includes fireworks;

FIG. 5 is a view describing maximum value composition;

FIG. 6 is a view describing a flow of extracting a person area;

FIG. 7 is a view illustrating an example of an image capturing scene;

FIG. 8 is a view illustrating an example of mask data;

FIG. 9 is a view illustrating an example of correction of mask data;

FIG. 10 is a view illustrating an example of a blend map;

FIG. 11 is a flowchart describing image capturing processing of the imaging apparatus; and

FIG. 12 is a flowchart describing image capturing processing of the imaging apparatus continuing from FIG. 11.

### DETAILED DESCRIPTION OF THE PREFERRED EMBODIMENTS

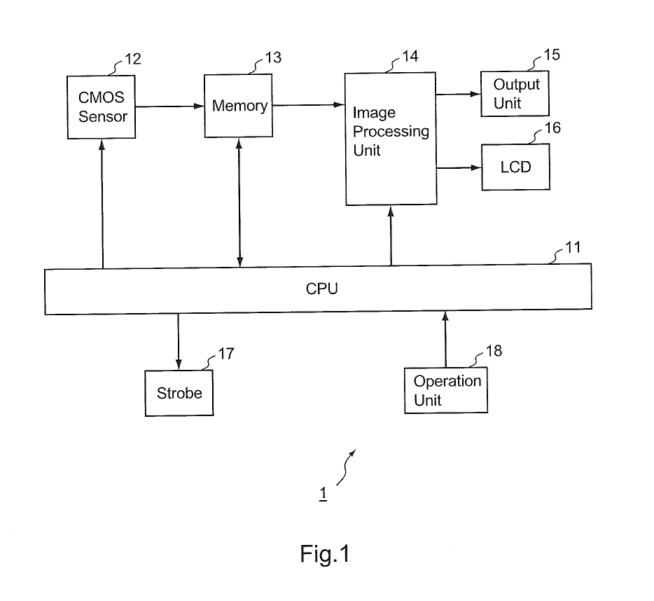

FIG. 1 is a block diagram illustrating a configuration example of an imaging apparatus 1 according to an exemplary embodiment. The imaging apparatus 1 is an apparatus such as a digital still camera, digital video camera or mobile telephone having a function of capturing still images.

A CPU (Central Processing Unit) 11 executes a predetermined program, and controls the entire operation of the imaging apparatus 1. As will be described below, the CPU 11 classifies a scene on which an image is to be captured by the user before the shutter button is pushed. The image capturing scene is classified based on a live preview image acquired from a CMOS (Complementary Metal Oxide Semiconductor) sensor 12. When the shutter button is pushed, the CPU 11 controls the CMOS sensor 12 to continuously capture images and controls the strobe 17 to emit light to execute image capturing processing optimal for the image capturing scene classified in advance.

The CMOS sensor 12 photoelectrically converts light taken in by a lens, and A/D (Analog/Digital) converts an image signal obtained by photoelectric conversion. The CMOS sensor 12 stores image data obtained by A/D conversion, in a memory 13.

An image processing unit 14 reads the image data, acquired from the CMOS sensor 12 before the shutter button is pushed and stored in the memory 13, as a live preview image and displays the live preview image on a LCD (Liquid Crystal Display) 16. Further, when the CPU 11 classifies the image capturing scene, on which the user will capture an image, as a night scene, the image processing unit 14 processes a plurality of images continuously captured in response to pushing of the shutter button to make one composed image and outputs it to an output unit 15 or LCD 16. The CPU 11 supplies to the image processing unit 14 information showing a classification result of the image capturing scene. Further, when the CPU 11 classifies the image capturing scene, on which the user will capture an image, as a normal scene such as an outdoor scene instead of a night scene, the image processing unit 14 captures one image and applies various image processings such as white balance processing and outline emphasis processing to the captured image.

The output unit 15 stores the composed image generated by the image processing unit 14, in a memory card which is attachable to the imaging apparatus 1, or transmits the composed image to an external apparatus. The LCD 16 displays the live preview image or the composed image supplied from the image processing unit 14.

The strobe 17 emits light according to control of the CPU 11, and radiates light on the subject. An operation unit 18 has various buttons such as the shutter button, and outputs a signal showing content of a user's operation, to the CPU 11 when a button is operated.

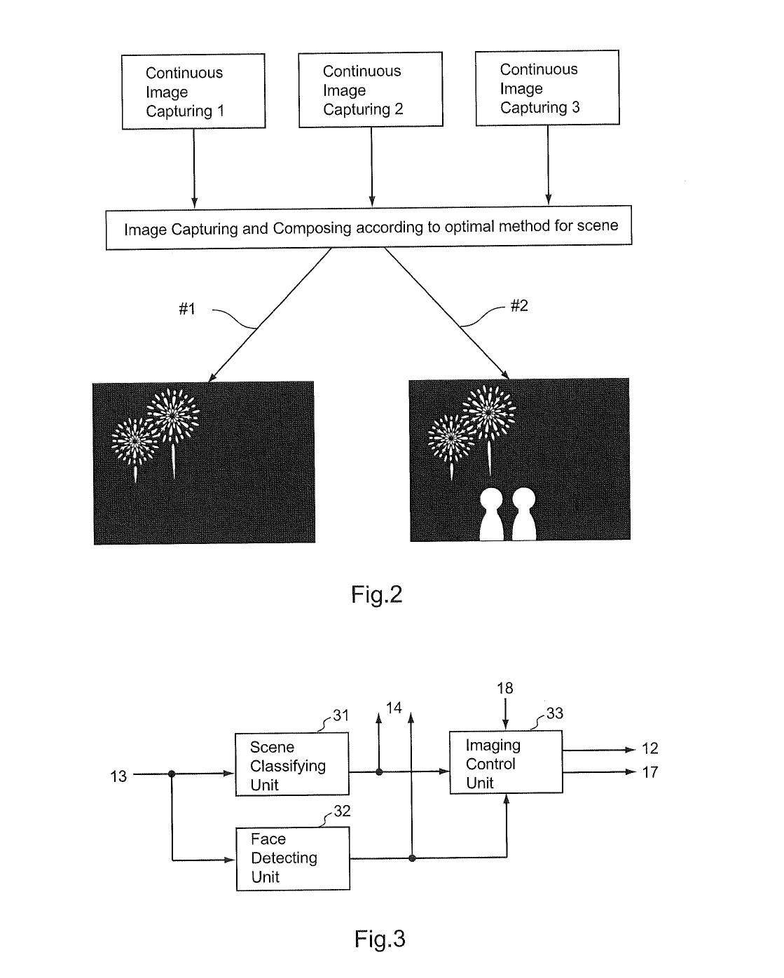

FIG. 2 is a view conceptually illustrating image capturing processing of the imaging apparatus 1 employing the above configuration. When the image capturing scene is classified as a night scene, the continuous image capturing function is automatically set to ON, and a plurality of images are continuously captured as illustrated in FIG. 2 in response to user's pushing of the shutter button once. In the example shown in FIG. 2, two images are obtained by the continuous image capturing function.

The processing of the images continuously captured in the imaging apparatus 1 can be selected from, for example, one for an image of bright fireworks with a motion being captured as indicated at the destination of an arrow #1 and another for a person being captured with a background such as bright fireworks with a motion as indicated at the destination of an arrow #2. Hereinafter, a case will be described where a subject which is bright and has a motion with respect to the background is fireworks. The same processing is applicable to a case where images of other subjects such as headlights of cars are captured.

FIG. 3 is a block diagram illustrating a functional configuration example of the imaging apparatus 1 for realizing image capturing processing described with reference to FIG. 2. At least part of the functional units illustrated in FIG. 3 is realized by executing a predetermined computer program by the CPU 11 in FIG. 1.

As illustrated in FIG. 3, in the imaging apparatus 1, a scene classifying unit 31, a face detecting unit 32 and an imaging control unit 33 are realized. The image which is captured by the CMOS sensor 12 and stored in the memory 13 is input to the scene classifying unit 31 and face detecting unit 32.

The scene classifying unit 31 analyzes an image acquired as a live preview image before the shutter button is pushed, and classifies a scene on which the user will capture an image, from a plurality of scenes such as a portrait scene, a scenery scene and a night scene set in advance.

When, for example, an image having the number of green or sky blue pixels greater than a threshold is acquired, the image capturing scene would be classified as a scenery scene. When an image having the number of black pixels greater than a threshold and including pixels of a high brightness value in an area of the black pixels is acquired, the image capturing scene would be classified as a night scene.

Further, when classifying the image capturing scene as a night scene, the scene classifying unit 31 decides whether or not the subject includes fireworks based on the live preview images. That is, the scene classifying unit 31 decides whether or not an image of fireworks is included in the live preview images.

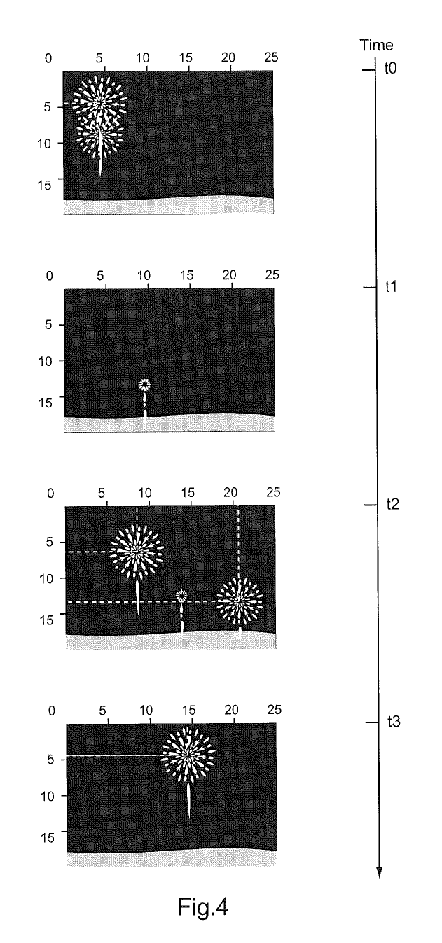

FIG. 4 is a view describing a method of deciding whether or not the subject includes fireworks. The vertical axis in FIG. 4 indicates time, and four images illustrated on the left side are live preview images. In FIG. 4, the position on an image will be described based on the reference (0, 0) on the upper left corner of each image.

The scene classifying unit 31 analyzes a preview image acquired at a time t0. In this example, it is detected that the coordinate of the brightest block (a group of pixels) is near (5, 5) and the average brightness of the entire image is relatively bright compared to the other preview images. Further, the scene classifying unit 31 analyzes the next preview image acquired at the time t1 a predetermined time after a time t0. It is detected in this example that the coordinate of the brightest block is not clear and the average brightness of the entire image is relatively dark compared to the other preview images. In this case, the scene classifying unit 31 decides that the preview image acquired at the time t1 shows fireworks immediately after the fireworks are fired off.

Similarly, the scene classifying unit 31 analyzes the next preview image acquired at a time t2 a predetermined time after the time t1. It is detected in this example that the coordinate of the brightest block is near (9, 6) or (21, 13) and the average brightness of the entire image is relatively bright compared to the other preview images. The scene classifying unit 31 analyzes the next preview image acquired at the time t3 a predetermined time after the time t2. It is detected in this example that the coordinate of the brightest block is near (14, 5), and the average brightness of the entire image is relatively and slightly bright compared to the other images.

In such analysis, the scene classifying unit 31 decides in this example that the subject includes fireworks, based on both of criteria that a position of a brightest block changes gradually in the live preview images and that entire brightness of each image changes gradually in the live preview images. Alternatively, the decision whether the subject includes fireworks can be carried by one of the above-mentioned criteria.

If a microphone is provided on the imaging apparatus 1, the scene classifying unit 31 may analyze the volume of sound collected by the microphone and decide that the subject includes fireworks when the brightness of the entire image and sound volume are proportional. This is because the brighter fireworks are, the grater the volume of sound such as audiences' cheer and noise would be. If a posture sensor is provided on the imaging apparatus 1, it may be decided that the subject includes fireworks when the posture of the imaging apparatus 1 which is detected by the sensor is parallel to the horizontal direction or is oriented above (toward the sky). This is because a user would usually orient the imaging apparatus 1 above from the horizontal direction for capturing an image of fireworks.

By so doing, it is possible to, for example, easily or accurately decide whether or not the subject includes fireworks.

The scene classifying unit 31 outputs to the imaging control unit 33 and image processing unit 14 information about the image capturing scene classified as described above and information showing whether or not the subject includes fireworks when classifying the image capturing scene as a night scene.

The face detecting unit 32 analyzes the image acquired as a live preview image before the shutter button is pushed, and detects a human face from the acquired image. For example, the face detecting unit 32 detects a human face or human faces by comparing features of human faces prepared in advance and features of each area of the acquired image. The face detecting unit 32 outputs to the imaging control unit 33 and image processing unit 14 information showing whether or not the image shows a human face or human faces, according to the detection result.

Based on information supplied from the scene classifying unit 31 and face detecting unit 32, the imaging control unit 33 set the image capturing mode and, when the user pushes the shutter button, controls the CMOS sensor 12 and strobe 17 according to the image capturing mode to capture an image.

When, for example, the scene classifying unit 31 classifies the image capturing scene as a night scene, the imaging control unit 33 sets continuous image capturing to ON. When the user pushes the shutter button, the imaging control unit 33 controls the CMOS sensor 12 according to this setting to continuously capture a plurality of images.

If the image capturing scene is classified as a night scene and the face detecting unit 32 detects a human face or human faces, the imaging control unit 33 controls the strobe 17 to emit light upon first image capturing or final image capturing on capturing a plurality of imaged continuously in response to user's pushing of the shutter button. Light of the strobe 17 radiates the person(s), and the image which is captured first or last with light emitted from the strobe 17 shows the person(s) brightly.

As described above, in the imaging apparatus 1, the image capturing mode is set to perform continuous image capturing when the image capturing scene is classified as a night scene. When the image capturing scene is classified as a night scene and a human face is detected, the image capturing mode is set to emit light from the strobe 17 upon the first image capturing or final image capturing in image capturing which is continuously performed a plurality of times.

Hereinafter, switching of processing of the image processing unit 14 will be described. In the image processing unit 14, processing performed using the image captured as described above when the user pushes the shutter button is switched according to the decision result in the scene classifying unit 31 and face detecting unit 32.

When the image capturing scene is a night scene and includes fireworks, a plurality of images captured by continuous image capturing function are supplied to the image processing unit 14.

In this case, the image processing unit 14 combines a plurality of images captured by the continuous image capturing function by maximum value composition to make a composed image. Maximum value composition refers to processing of combining a plurality of images such that a pixel value of each pixel in the composed image is set by a highest pixel value or brightness value among the pixel values of the corresponding pixels (the pixels of the same coordinates of respective images) in a plurality of images captured. In the following description, it will be described where an image is composed such that the pixel value of the pixel having the highest pixel value is used as the pixel value of each pixel of a composed image. It is also possible to use the pixel value of a pixel having the highest brightness value as the pixel value of each pixel of the composed image.

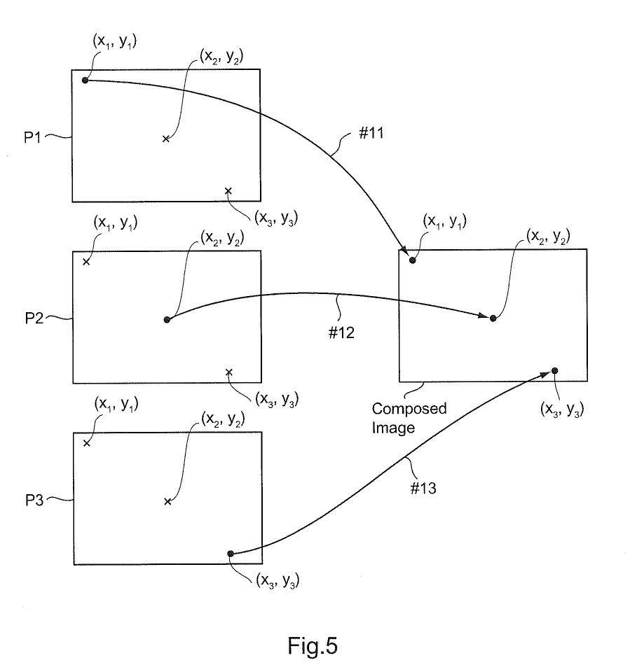

FIG. 5 is a view describing maximum value composition Images P1 to P3 illustrated on the left side of FIG. 5 are captured in order by the continuous image capturing function, and an image illustrated on the right side is a composed image. A case will be described where a pixel value of each pixel at the positions of coordinates (x1, y1), (x2, y2) and (x3, y3) of a composed image is found.

To find the pixel value of the pixel of the coordinate (x1, y1) in the composed image, the image processing unit 14 compares the pixel value of a pixel at the coordinate (x1, y1) in the image P1, the pixel value of the pixel at the coordinate (x1, y1) of the image P2 and the pixel value of the pixel at the coordinate (x1, y1) in the image P3, and selects the pixel value of the pixel having the maximum pixel value as the pixel value of the pixel at the coordinate (x1, y1) in the composed image. With the example of FIG. 5, as indicated at the destination of an arrow #11, the pixel value of the pixel at the coordinate (x1, y1) in the composed image is selected as the pixel value of the pixel at the coordinate (x1, y1) in the image Pl.

Further, to find the pixel value of the pixel at the coordinate (x2, y2) in the composed image, the image processing unit 14 compares the pixel value of the pixel at the coordinate (x2, y2) in the image P1, the pixel value of the pixel at the coordinate (x2, y2) in the image P2 and the pixel value of the pixel at the coordinate (x2, y2) in the pixel P3, and selects the pixel value of the pixel having the maximum pixel value, as the pixel value of the pixel at the coordinate (x2, y2) in the composed image. With the example of FIG. 5, as indicated at the destination of an arrow #12, the pixel value of the pixel at the coordinate (x2, y2) in the composed image is selected as the pixel value of the pixel at the coordinate (x2, y2) in the image P2.

Similarly, to find the pixel value of the pixel at the coordinate (x3, y3) in the composed image, the image processing unit 14 compares the pixel value of the pixel at the coordinate (x3, y3) in the image P1, the pixel value of the pixel at the coordinate (x3, y3) in the image P2 and the pixel value of the pixel at the coordinate (x3, y3) in the pixel P3, and selects the pixel value of the pixel having the maximum pixel value, as the pixel value of the pixel at the coordinate (x3, y3) in the composed image. With the example of FIG. 5, as indicated at the destination of an arrow #13, the pixel value of the pixel at the coordinate (x3, y3) in the composed image is selected as the pixel value of the pixel at the coordinate (x3, y3) in the image P3.

When the image capturing scene is a night scene and shows fireworks, the image processing unit 14 combines a plurality of images captured by the continuous image capturing function by maximum value composition to generate one composed image. By processing the pixel value in this way when the pixel value of each pixel is represented by 8 bits and white is represented by RGB=(255, 255, 255), even images which are not sufficiently exposed are composed by collecting bright pixels from a plurality of images, so that it is possible to obtain a composed image in which an adequate exposure is provided at the portion of fireworks. That is, when an image of fireworks is generally captured by setting the exposure of a long second for an insufficient exposure and for keeping a trajectory of a flash, if an adequate time second is not selected, the exposure becomes excessive, thereby losing details and contrast. Hence, by using the above continuous image capturing and maximum value composition, it is possible to provide an adequate exposure for fireworks while suppressing an over exposure.

Similar to the case where the image capturing scene shows fireworks, when the image capturing scene is a night scene, and does not show fireworks, a plurality of images captured by the continuous image capturing function are supplied to the image processing unit 14.

In this case, the image processing unit 14 combines a plurality of images captured by the continuous image capturing function by additive composition or average composition to generate one composed image. Additive composition refers to processing of combining a plurality of images such that a pixel value of each pixel in the composed image is set by a sum of pixel values of the corresponding pixels in a plurality of images captured by the continuous image capturing function. If a pixel value exceeds an upper limit value (for example, 255) as a result of addition, the pixel value of the entire image can be decreased at the ratio that the maximum value becomes an upper limit value.

By contrast with this, average composition refers to processing of composing a plurality of images such that a pixel value of each pixel in the composed image is set by an average value of pixel values of the corresponding pixels in the plurality of images captured by the continuous image capturing function. Average composition is selected when, for example, in a composed image obtained by additive composition, the ratio of over-exposed pixels of saturated pixel values exceeds a predetermined ratio.

When the image capturing scene is a night scene and does not show fireworks, the image processing unit 14 combines a plurality of images captured by the continuous image capturing function by additive composition or average composition to generate one composed image. By this means, it is possible to obtain a composed image showing a night scene at an adequate exposure. In addition, it may be possible to correct camera shake of a plurality of images captured by the continuous image capturing function, and perform additive composition or average composition based on the images after camera shake correction.

When the image capturing scene is a night scene and shows a human face or human faces, a plurality of images captured by the continuous image capturing function are supplied to the image processing unit 14. Images which are captured first and last among a plurality of images supplied to the image processing unit 14 are captured with light emission from the strobe 17.

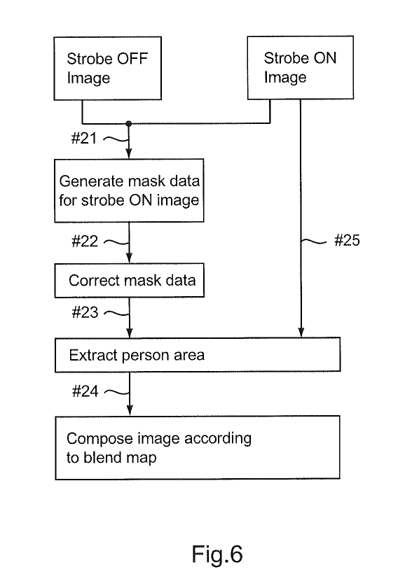

FIG. 6 is a view describing a flow of extraction of a person area. As indicated at the destination of an arrow #21, the image processing unit 14 finds the difference between brightness values of an image captured without light emission from the strobe 17 and an image captured first and last with light emission from the strobe 17 among a plurality of images captured by the continuous image capturing function to generate mask data. The mask data is used to extract a person area from the image captured with light emission from the strobe 17.

Hereinafter, the image captured with light emission from the strobe 17 is referred to as a strobe ON image, and the image captured without light emission from the strobe 17 is referred to as a strobe OFF image.

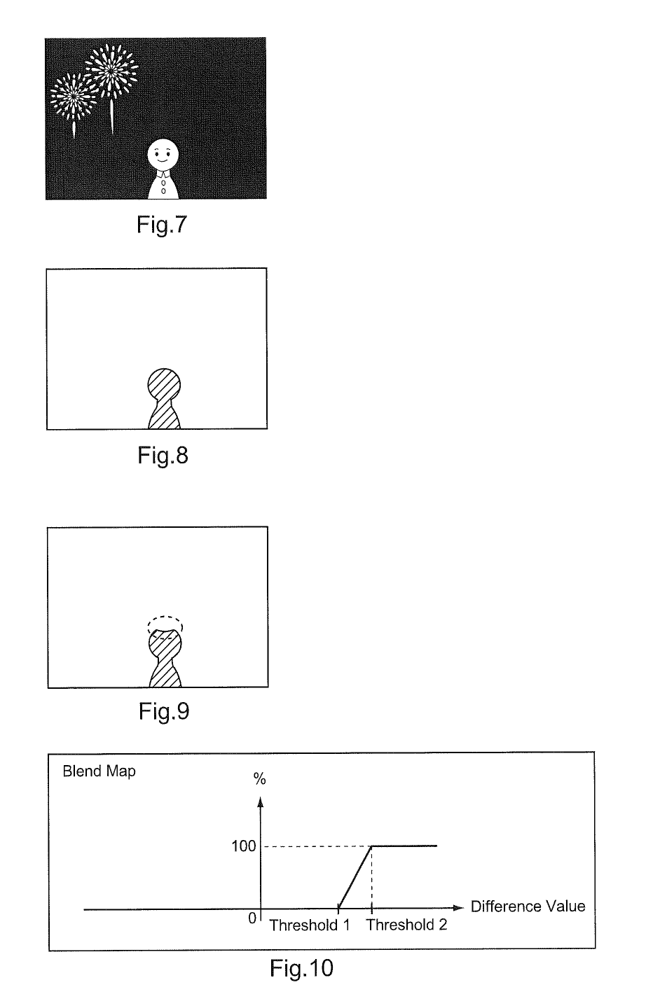

As illustrated in FIG. 7, a case will be described where an image of a person is captured with fireworks in the background. When an image is captured with light emission from the strobe 17, a brightness value of an area of a person in the captured image is higher than a brightness value of an area in the background. By contrast with this, when an image is captured without light emission from the strobe 17, a brightness value of a person area in the captured image becomes low similar to a brightness value of an area in the background.

The image processing unit 14 finds a difference between brightness values of a strobe ON image and strobe OFF image per area, and generates mask data which indicates the area having the brightness difference equal to or more than a threshold as illustrated in FIG. 8. With the mask data illustrated in FIG. 8, the area indicated by diagonal lines is an area having the difference between brightness values of a strobe ON image and strobe OFF image equal to or more than a threshold, and corresponds to the person area.

After mask data is generated, as indicated at the destination of an arrow #22 of FIG. 6, the image processing unit 14 corrects mask data. In this processing, the mask data is corrected to include in the person area a portion which is part of a person yet is not detected as the person area in mask data because light from the strobe 17 does not radiate this portion (the portion having the difference between brightness values of a strobe ON image and strobe OFF image being not equal to or greater than a threshold).

There are cases where, when, for example, an image is captured with light emission from the strobe 17, light does not reach above the head of the person. In this case, the shape of the portion of the head of the person area of mask data has a dented shape as illustrated by a broken line circle in FIG. 9. The image processing unit 14 corrects mask data to make this dented shape a shape without a dent as illustrated in FIG. 8. It is possible to predict in which range the entire head is based on the human face detected by the face detecting unit 32, and the image processing unit 14 predicts, for example, the range of the entire head and corrects mask data.

After mask data is corrected, as indicated at the destinations of an arrow #23 and arrow #25 in FIG. 6, the image processing unit 14 extracts the person area from the strobe ON image using mask data. The area on the image corresponding to the area illustrated by diagonal lines in FIG. 8 when mask data is superimposed is a person area shown in the strobe ON image.

After the person area is extracted from the strobe ON image, as indicated at the destination of an arrow #24 in FIG. 6, the image processing unit 14 combines the image of the person area with the composed image according to a blend map. The composed image with which the person area is combined is the image generated by maximum value composition when the image capturing scene is a night scene and shows fireworks as described above, and is an image generated by additive composition or average composition when the image capturing scene does not show fireworks.

FIG. 10 is a view illustrating an example of a blend map. The horizontal axis in FIG. 10 indicates the difference between brightness values of a strobe ON image and strobe OFF image, and the vertical axis indicates the composition ratio of pixel values of pixels of the person area extracted from the strobe ON image. When, for example, the composition ratio is 50%, this means that a pixel value obtained by blending 50% of the pixel values of the pixels of the composed image and pixel values of the pixels of the person area extracted from the strobe ON image is used as the pixel values of the pixels of the person area in the composed image which is finally obtained.

With the example of FIG. 10, when the difference between brightness values of the strobe ON image and strobe OFF image is a threshold 1 or less, the composition ratio of the pixel values of the pixels of the person area extracted from the strobe ON image is 0%. Further, when the brightness difference is the threshold 1 or more and is less than a threshold 2, the composition ratio of the pixel values of the pixels of the person area extracted from the strobe ON image increases linearly from 0% to 100% in proportion to the brightness difference. Furthermore, when the brightness difference is the threshold 2 or more, the composition ratio of the pixel values of the pixels of the person area extracted from the strobe ON image is 100%.

For the image processing unit 14, information about this blend map is set in advance. When the image capturing scene is a night scene and shows the face of the person, the image processing unit 14 combines the image of the person area extracted from the strobe ON image, with the composed image according to the blend map.

By this means, it is possible to obtain a composed image of the background and person at an adequate exposure. As described above, the background is adequately exposed by composition processing such as maximum value composition, additive composition and average composition. Further, an adequate exposure is provided with the person in the composed image by capturing his image with light emission from the strobe 17.

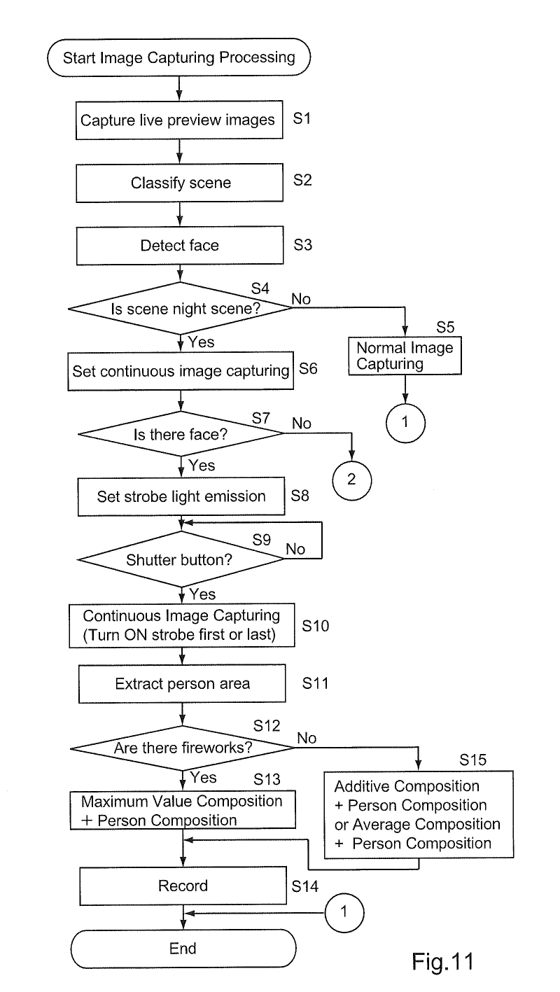

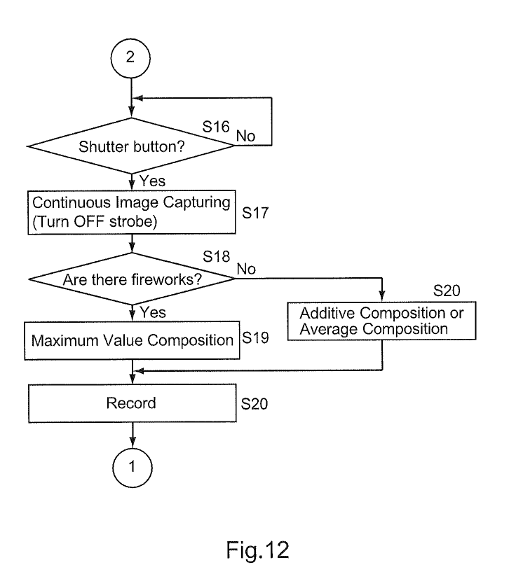

Image capturing processing of the imaging apparatus 1 will be described with reference to the flowcharts in FIGS. 11 and 12.

In step S1, the imaging control unit 33 controls the CMOS sensor 12 to capture live preview images. The captured live preview images are stored in the memory 13, and then supplied to the scene classifying unit 31 and face detecting unit 32 and read by the image processing unit 14 to be displayed on the LCD 16.

In step S2, the scene classifying unit 31 analyzes the live preview image and classifies the image capturing scene. Further, when classifying the image capturing scene as the night scene, the scene classifying unit 31 detects whether or not the subject includes fireworks.

In step S3, the face detecting unit 32 analyzes the live preview images and detects a human face or human faces.

In step S4, the scene classifying unit 31 decides whether or not the image capturing scene is a night scene. In step S4, when it is decided that the image capturing scene is not a night scene, the process proceeds to step S5 and the imaging control unit 33 performs normal image capturing according to the image capturing scene. That is, the imaging control unit 33 sets parameters matching the image capturing scene such as a portrait scene or scenery scene, and captures the image in response to pushing of the shutter button. After the image processing unit 14 performs various image processings of the captured image, the captured image is supplied to the output unit 15. The output unit 15 records image data in a recording medium, and then normal image capturing processing is finished.

By contrast with this, in step S4, when it is decided that the image capturing scene is a night scene, the process proceeds to step S6, and the imaging control unit 33 sets continuous image capturing to ON.

In step S7, the imaging control unit 33 decides whether or not the face detecting unit 32 detects a human face or human faces, and, when the imaging control unit 33 decides that at least one human face is detected, the imaging control unit 33 proceed tithe the process to step S8 to set the strobe 17 to emit light upon first image capturing or last image capturing.

In step S9, the imaging control unit 33 decides whether or not the shutter button is pushed based on a signal supplied from the operation unit 18, and stands by until it is decided that the shutter button is pushed.

In step S9, when the imaging control unit 33 decides that the shutter button is pushed, the imaging control unit 33 proceeds with the process to step S10 to control the CMOS sensor 12 to capture a plurality of images by the continuous image capturing function. Further, the imaging control unit 33 controls the strobe 17 to emit light upon first image capturing or last image capturing. A plurality of images captured by the continuous image capturing function are stored in the memory 13 and then are supplied to the image processing unit 14.

In step S11, as described above, the image processing unit 14 generates mask data based on the difference between brightness values of the strobe ON image and strobe OFF image and then adequately corrects this mask data (FIGS. 8 and 9), and extracts the image of the person area from the strobe ON image using mask data.

In step S12, the image processing unit 14 decides whether or not the scene classifying unit 31 detects fireworks, and, when the scene classifying unit 31 decides that fireworks are detected, the image processing unit 14 proceeds with the process to step S13 to combine a plurality of images by maximum value composition and to combine the obtained composed image with the image of the person area extracted from the strobe ON image. Data of the composed image with which the image of the person area extracted from the strobe ON image is combined is supplied from the image processing unit 14 to the output unit 15.

In step S14, the output unit 15 records in a recording medium data of the composed image generated by the image processing unit 14, and finishes processing.

In step S12, when it is decided that fireworks are not detected, the process proceeds to step S15, and the image processing unit 14 combines a plurality of images by additive composition or average composition, and combines the image of the person area extracted from the strobe ON image, with the obtained composed image. Then, the process proceeds to step S14, and, after the composed image is recorded, processing is finished.

In step S7, when the imaging control unit 33 decides that no human face is detected, the process proceeds to step S16 (FIG. 12) to decide whether or not the shutter button is pushed, and stand by until it is decided that the shutter button is pushed.

In step S16, when the imaging control unit 33 decides that the shutter button is pushed, the imaging control unit 33 proceeds with the process to step S17 to control the CMOS sensor 12 to capture a plurality of images by the continuous image capturing function. No human face is detected and therefore the strobe 17 does not emit light in this case. A plurality of images captured by the continuous image capturing function are stored in the memory 13 and then are supplied to the image processing unit 14.

In step S18, when the image processing unit 14 decides whether or not fireworks are detected and decides that fireworks are detected by means of the scene classifying unit 31, the image processing unit 14 proceed with the process to step S19 to combine a plurality of images by maximum value composition. Data of the composed image generated by maximum value composition is supplied from the image processing unit 14 to the output unit 15.

In step S20, the output unit 15 records in a recording medium data of the composed image generated by the image processing unit 14, and finishes processing.

By contrast with this, in step S18, when the image processing unit 14 decides that fireworks are not detected, the image processing unit 14 proceeds with the process to step S21 to combine a plurality of captured images by additive composition or average composition. Then, in step S20, after the composed image is recorded, processing is finished.

According to the above-mentioned exemplary embodiment; it can be achieved that;

1. An image capturing scene is classified before the shutter button is operated, so that, when the image capturing scene includes a night scene, it is possible to easily set an image capturing mode of performing continuous image capturing;

2. When a night scene includes fireworks, a plurality of images are combined such that a pixel value of each pixel in the composed image is set by a highest pixel value or brightness value among the pixel values of the corresponding pixels in the plurality of images captured by the continuous image capturing function, so that it is possible to easily capture a high quality image of a night scene with an adequate exposure for the portion of fireworks;

3. When the night scene does not include fireworks, a plurality of images are combined such that a pixel value of each pixel in the composed image is set by a sum of pixel values of the corresponding pixels in the plurality of images captured by the continuous image capturing function, or when a ratio of pixels on each of which the sum of pixel values of the corresponding pixels in the plurality of images exceeds a threshold exceeds a predetermined ratio, a pixel value of each pixel in the composed image is set by an average value of pixel values of the corresponding pixels in the plurality of images, so that it is possible to easily capture a high quality image of a night scene at an adequate exposure.

4. Light is emitted from a strobe when a human face is detected, a first image of a plurality of images is captured or the last image is captured, and, moreover, an area radiated by the strobe is extracted from the first image or the last image and the extracted area is superimposed on and combined with the composed image, so that it is possible to not only easily capture a high quality image of a night scene without camera shake at an adequate exposure but also capture an image of a person with optimal image quality.

The above series of processings may be executed by hardware or by software. When a series of processings are executed by software, a computer program configuring this software is installed from a computer program recording medium to a computer which is integrated in a dedicated hardware or, for example, a general-purpose personal computer which can execute various functions by installing various computer programs.

The present invention is by no means limited to the above exemplary embodiment, and can be embodied by deforming components within a range without deviating from the spirit of the invention at the stage of implementation, and form various inventions by adequately combining a plurality of components disclosed in the above exemplary embodiment. For example, some components may be deleted from all components disclosed in the exemplary embodiment. Further, components between different embodiments may be adequately combined.

What is claimed is:

1. An imaging apparatus comprising:
an image sensor;
a scene classifying means which analyzes a preview image acquired from the image sensor before a shutter button is operated, and classifies the scene on which the preview image is obtained;
an imaging control means which, when the scene classified by the scene classifying unit is a night scene including a night view, controls the image sensor to continuously capture a plurality of images when the shutter button is operated.

2. The imaging apparatus according to claim 1, in which:
the scene classifying means decides whether or not an image of fireworks is included in the preview image when the scene on which the preview image is obtained is classified as a night scene, and
the imaging apparatus further comprises an image processing means which processes the plurality of images to make a composed image such that, when it is decided that an image of fireworks is included, a pixel value of each pixel in the composed image is set by a highest pixel value or brightness value among the pixel values of the corresponding pixels in the plurality of images captured when the shutter button is operated.

3. The imaging apparatus according to claim 2, in which: the image processing means processes the plurality of images to make a composed image such that, when it is decided that an image of fireworks is not included, a pixel value of each pixel in the composed image is set by a sum of pixel values of the corresponding pixels in the plurality of images captured when the shutter button is operated.

4. The imaging apparatus according to claim 3, in which: the image processing means makes a composed image such that, when a ratio of pixels on each of which the sum of pixel values of the corresponding pixels in the plurality of images exceeds a threshold exceeds a predetermined ratio, a pixel value of each pixel in the composed image is set by an average value of pixel values of the corresponding pixels in the plurality of images.

5. The imaging apparatus according to claim 1, further comprising:
a face detecting means which detects a face of a person in an image acquired from the image sensor; and
a light emitting means which makes a strobe emit light,
in which:
when the face detecting means detects a face of a person in the preview image, the control means controls the light emitting means to make the strobe emit light when a first image or a last image among the plurality of images is captured.

6. The imaging apparatus according to claim 2, further comprising:
a face detecting means which detects a human face in an image acquired from the image sensor; and
a light emitting means which makes a strobe emit light,
in which:
when the face detecting means detects a face of a person in the preview image, the control means controls the light emitting means to make the strobe emit light when a first image or a last image among the plurality of images is captured, and
the image processing means extracts an area radiated by a strobe from the first image or the last image, and superimposes the extracted area on the composed image.

7. An imaging method of an imaging apparatus comprising an image sensor, the imaging method comprising:
analyzing a preview image acquired from the image sensor before a shutter button is operated to classify the scene on which the preview image is obtained; and
when the scene is classified as a night scene including a night view, controlling the image sensor to continuously capture a plurality of images when the shutter button is operated.

8. A computer program of causing a computer to execute image capturing processing of an imaging apparatus comprising an image sensor, the computer program comprising:
analyzing a preview image acquired from the image sensor before a shutter button is operated to classify the scene on which the preview image is obtained; and
when the scene is classified as a night scene including a night view, controlling the image sensor to continuously capture a plurality of images when the shutter button is operated.

9. The imaging apparatus according to claim 3, further comprising:
a face detecting means which detects a human face in an image acquired from the image sensor; and
a light emitting means which makes a strobe emit light,
in which:
when the face detecting means detects a face of a person in the preview image, the control means controls the light emitting means to make the strobe emit light when a first image or a last image among the plurality of images is captured, and
the image processing means extracts an area radiated by a strobe from the first image or the last image, and superimposes the extracted area on the composed image.

10. The imaging apparatus according to claim 4, further comprising:
a face detecting means which detects a human face in an image acquired from the image sensor; and
a light emitting means which makes a strobe emit light,
in which:
when the face detecting means detects a face of a person in the preview image, the control means controls the light emitting means to make the strobe emit light when a first image or a last image among the plurality of images is captured, and
the image processing means extracts an area radiated by a strobe from the first image or the last image, and superimposes the extracted area on the composed image.
